(19) United States
(12) Patent Application Publication
(10) Pub. No.: US 2012/0059496 A1
(43) Pub. Date: Mar. 8, 2012

(54) Method and device for transmitting audio data over universal serial bus by a wireless data terminal

(75) Inventors: Wenqiang Gong, Shenzhen (CN); Chengzhi Jiang, Shenzhen (CN); Suguang Guo, Shenzhen (CN)

(73) Assignee: ZTE CORPORATION, Shenzhen, Guangdong (CN)

(21) Appl. No.: 13/258,139

(22) PCT Filed: Dec. 11, 2009
(86) PCT No.: PCT/CN09/75508

§ 371 Date: Nov. 18, 2011

(30) Foreign Application Priority Data
May 25, 2009 (CN) 200910085521.0

(51) Int. Cl. G06F 17/00

(52) U.S. Cl. 700/94

(57) ABSTRACT

A method and a device for transmitting audio data over Universal Serial Bus (USB) audio data by a wireless data terminal are disclosed. The method includes that: a USB audio data transmission channel between a wireless data terminal and terminal equipment is set as USB sound card equipment by adopting the standard USB AUDIO CLASS defined by the USB specification, to transmit audio data; the device includes a wireless data terminal, USB sound card equipment, and terminal equipment. The USB sound card equipment only transmits audio data, and does not process audio data; a USB audio equipment driver of the terminal equipment accesses a USB endpoint of the terminal equipment in a manner of accessing a sound card interface. By adopting the method and the device of the present invention, the USB audio data transmission channel is specifically optimized, and the powerful audio data processing capability of terminal equipment is fully utilized to enhance the effectiveness of Voice Over USB (VOUSB) in the practical application.

### TECHNICAL FIELD

The present invention relates to the field of an audio data transmission technology, and particularly to a method and a device for transmitting audio data over universal serial bus by a wireless data terminal.

### BACKGROUND

At present, a Time Division-Synchronous Code Division Multiple Access (TD-SCDMA) technology, as the 3^{rd} Generation Mobile Communication Standard put forward by China, has become more and more mature. Supported by the TD-SCDMA technology, the speeds of downloading data from a network and uploading data to a network are greatly increased, thus certainly increasing the demand of users for audio services and video services.

Currently, when processing audio data, a wireless data terminal directly sends an analog audio signal received via an air interface to the corresponding hardware equipment, such as a radio frequency device and a codec etc., to be demodulated and decoded, and finally played by a loudspeaker. An analog audio signal which is acquired by a microphone and needs to be sent are sent after being coded and modulated by the corresponding hardware equipment, such as a codec and radio frequency device etc. Such an audio data processing method has the following disadvantage: since audio data needs to be coded and decoded, a corresponding codec should be provided for a wireless data terminal, thereby increasing hardware cost.

In order to overcome the disadvantage of the aforementioned audio data processing method, Voice Over USB (VOUSB) is used as a relatively popular realization method currently, which will be simply described by taking a widely-applied Personal Computer (PC) serving as the terminal equipment as an example. A wireless data terminal transmits demodulated audio data to the PC over Universal Serial Bus (USB) interface, and the demodulated audio data are processed, such as decoded etc; similarly, the audio data having been processed (such as coded etc.) in the PC is transmitted to the wireless data terminal via a USB interface. In this way, the wireless data terminal does not need a codec on the hardware, thereby reducing the hardware cost. In addition, compared with the wireless data terminal, the PC has a stronger computing capability and more memory resources, thus providing a more powerful audio data processing capability to perform more rich processing, such as de-noising, retouching and audio-mixing etc.

FIG. 1 shows a schematic diagram illustrating a solution for realizing a VOUSB in the existing technology. As shown in FIG. 1, an air interface of a wireless data terminal receives an analog audio signal which is sent from remote equipment through a wireless communication network and transmits the analog audio signal to a radio frequency to be demodulated. Subsequently, a baseband processing module performs amplification and digital filtering processing on the demodulated audio signal to obtain a Pulse Code Modulation (PCM) code stream which is then transmitted to a USB driver at the wireless data terminal side, further the PCM code stream is transmitted to a USB endpoint of the wireless data terminal by the USB driver at the wireless data terminal side, and then the PCM code stream is transmitted to a USB endpoint of the terminal equipment through the USB endpoint of the wireless data terminal according to a bulk transmission mode of a USB standard. Here, the USB driver at the wireless data terminal side is used for receiving the audio data from the baseband processing module and transmitting the audio data to the USB endpoint of the wireless data terminal, or is used for reading the audio data from the USB endpoint of the wireless data terminal and transmitting the audio data to the baseband processing module. The bulk transmission mode of the USB standard supports massive data transmission within an undetermined period of time, which can ensure the data transmission accuracy. However, since the transmission bandwidth and delay cannot be guaranteed, the real-time performance of the data transmission is bad. In addition, the terminal equipment is not provided with a standard equipment driver to process the audio data transmitted according to the bulk transmission mode of the USB standard, thus it will need an application User Interface (UI) to process the audio data, wherein an implementation method of an audio data processing by an application UI is as follows:

a PCM code stream sent from the wireless data terminal to the USB endpoint of the terminal equipment is read by the USB driver at the terminal equipment side, and further is read from the USB driver and processed by a UI of the terminal equipment, and subsequently the processed PCM code stream is transmitted to a physical sound card; the physical sound card decodes the transmitted PCM code stream which then undergoes A/D conversion to acquire an analog audio signal; the analog audio signal is finally sent to a loudspeaker to be played; wherein the physical sound card can be a Peripheral Component Interconnect (PCI) interface sound card or a USB sound card etc.; here, the USB driver at the terminal equipment side is used for reading the audio data from the USB endpoint of the terminal equipment and transmitting the audio data to the UI, or is used for acquiring the audio data from the UI and transmitting the audio data to the USB endpoint of the terminal equipment.

The aforementioned description shows that, in the realization solution for the VOUSB, the USB audio data transmission channel between the wireless data terminal and the terminal equipment only functions as a data transmission channel, thus resulting in a problem that it does not perform special optimization according to the characteristics of the audio data transmission, which influences the effect of the VOUSB in practical application with respect to real-time performance and etc.

### SUMMARY

In view of this, the main purpose of the present invention is to provide a method and a device for transmitting audio data over USB by a wireless data terminal, which fully utilizes the powerful audio data processing capability of the terminal equipment to enhance the effectiveness of the VOUSB in the practical application.

In order to solve the aforementioned technical problem, the technical solution of the present invention is realized as follows.

A method for transmitting audio data over USB by a wireless data terminal, wherein a USB audio data transmission channel between a wireless data terminal and a terminal equipment is set as USB sound card equipment, wherein the method comprises:

the wireless data terminal sends audio data to the terminal equipment through the USB sound card equipment and the terminal equipment uses its audio equipment driver to access the USB sound card equipment to acquire the audio data; and
the terminal equipment uses its audio equipment driver to send the audio data to the USB sound card equipment, and the wireless data terminal receives the audio data through the USB sound card equipment.

The step of the USB audio data transmission channel between the wireless data terminal and the terminal equipment is set as the USB sound card equipment may comprise:

the wireless data terminal defines a USB endpoint of the wireless data terminal, the USB endpoint transmits the audio data as a sound card, and the USB endpoint of the wireless data terminal is connected to a terminal equipment USB endpoint via a USB data cable;

the terminal equipment sends a request to the wireless data terminal for acquiring a device descriptor, a configuration descriptor and a descriptor assemble; after receiving the request, the wireless data terminal sends the device descriptor, the configuration descriptor and the descriptor assemble to the terminal equipment; and

after determining that a USB driver can be provided according to the device descriptor, the configuration descriptor and the descriptor assemble, the terminal equipment loads a corresponding audio equipment driver in accordance with a USB specification and the audio equipment driver configures the sound card to obtain the USB sound card equipment.

The terminal equipment may comprise an audio equipment driver, a UI and a physical sound card;

the step that the terminal equipment uses its audio equipment driver to access the USB sound card equipment to acquire audio data may comprise that: the audio equipment driver accesses the USB sound card equipment in a manner of accessing an interface of the USB sound card equipment, releases and reads a PCM code stream transmitted to the USB sound card equipment; the UI accesses the audio equipment driver via an audio equipment interface and transmits the PCM code stream to the physical sound card

The terminal equipment may comprise an audio equipment driver, a UI and a physical sound card;

the step that the terminal equipment uses its audio equipment driver to send audio data to the USB sound card equipment, may comprise that: the physical sound card acquires a PCM code stream from an analog audio signal; the UI acquires the PCM code stream from the physical sound card and transmits the PCM code stream to the audio equipment driver via an audio equipment interface of the audio equipment driver; the audio equipment driver sends the PCM code stream to the USB sound card equipment.

The step that the wireless data terminal transmits audio data to the terminal equipment through the USB sound card equipment may comprise that: a baseband processing module of the wireless data terminal transmits a PCM code stream acquired after being processed to a USB driver at the wireless data terminal side of the USB sound card equipment.

The step that the wireless data terminal receives audio data through the USB sound card equipment may comprise that: a baseband processing module of the wireless data terminal acquires a PCM code stream transmitted to a USB endpoint of the wireless data terminal through a USB driver at the wireless data terminal side of the USB sound card equipment.

A device for transmitting USB audio data through a wireless data terminal, comprises:

a wireless data terminal, which is configured to send audio data to a terminal equipment through a USB sound card equipment, and further which is configured to receive the audio data from the terminal equipment through the USB sound card equipment;

a USB sound card equipment, which is set based on a USB audio data transmission channel between the wireless data terminal and the terminal equipment, and configured to transmit the audio data between the wireless data terminal and the terminal equipment;

a terminal equipment, which is configured to use its audio equipment driver to access the USB sound card equipment to acquire audio data from the wireless data terminal and further configured to use its audio equipment driver to send the audio data to the USB sound card equipment.

The USB sound card equipment may comprise: a USB driver at the wireless data terminal side, a USB endpoint of the wireless data terminal and a USB endpoint of the terminal equipment;

the USB driver at the wireless data terminal side is connected with a baseband processing module of the wireless data terminal;

the USB endpoint of the wireless data terminal is connected with the USB endpoint of the terminal equipment via a USB data cable;

the USB endpoint of the terminal equipment is connected with the audio equipment driver of the terminal equipment.

When the terminal equipment is configured to use its audio equipment driver to access the USB sound card equipment to acquire the audio data from the wireless data terminal, the terminal equipment may comprise:

an audio equipment driver, which is configured to access the USB endpoint of the terminal equipment in a manner of accessing an interface of the USB sound card equipment, read and release a PCM code stream transmitted to the USB endpoint of the terminal equipment;

a UI, which is configured to access the audio equipment driver via an audio equipment interface, and transmit the PCM code stream to a physical sound card;

a physical sound card, which is configured to acquire an analog audio signal from the PCM code stream.

When the terminal equipment is configured to use its audio equipment driver to send the audio data to the USB sound card equipment, the terminal equipment may comprise:

a physical sound card, which is configured to acquire a PCM code stream from an analog audio signal;

a UI, which is configured to acquire the PCM code stream from the physical sound card, and transmit the PCM code stream to the audio equipment driver via an audio equipment interface of the audio equipment driver;

an audio equipment driver, which is configured to send the PCM code stream to the USB endpoint of the terminal equipment.

It can be seen that, compared with the existing technology, the method and device for transmitting USB audio data through a wireless data terminal provided by the present invention can abstract and optimize the USB audio data transmission channel according to the characteristics of audio data transmission, and fully utilize the powerful audio data processing capability of the terminal equipment to enhance the effectiveness of VOUSB in practical application.

In addition, the solution of the present invention further has the following characteristics and advantages:

Firstly, a USB audio data transmission channel between a wireless data terminal and a terminal equipment is set as the USB sound card equipment by adopting the standard USB AUDIO CLASS defined by the USB specification, so as to transmit audio data; the operation system of the broadly-used terminal equipment provides realization for an audio equipment driver which satisfies the USB specification by default, therefore the audio equipment driver accesses a USB endpoint of the terminal equipment in the a manner of accessing an interface of the USB sound card equipment, and the audio equipment driver reads and releases audio data read from the USB endpoint.

Secondly, a synchronous transmission method which adopts the USB standard has a good real-time performance in transmitting audio data, and the terminal equipment is provided with a standard driver, namely the audio equipment driver, for the synchronous transmission method, therefore reading and releasing the audio data from the USB endpoint of the terminal equipment are completed in the audio equipment driver, which has a higher processing priority than the processing in the application of UI; thus, the processing for the audio data has a good real-time performance when the operation system of the terminal equipment is heavily-loaded.

Finally, the UI accesses the audio equipment driver via an audio equipment interface and transmits the released audio data to a physical sound card; since the UI accesses the audio equipment driver via the audio equipment interface, the reliability of the UI on the audio equipment driver is reduced; wherein the audio equipment interface is a standard interface, When the UI accesses the audio equipment interface, it need not take notice of the details for realizing the audio equipment driver at the bottom layer; in addition, the operation system has a good portability, which can realize the UI in a simpler and more reliable way.

### BRIEF DESCRIPTION OF THE DRAWINGS

FIG. 1 shows a schematic diagram illustrating a solution for realizing VOUSB in the existing technology;

FIG. 2 shows a block diagram illustrating a device for realizing USB audio data transmission through a wireless data terminal in the present invention;

FIG. 3 shows a schematic diagram of setting a USB audio data transmission channel as USB sound card equipment in the present invention;

FIG. 4 shows a transmission flowchart taking a wireless data terminal as an audio data receiver; and

FIG. 5 shows a transmission flowchart taking a wireless data terminal as an audio data transmitter.

### DETAILED DESCRIPTION

The present invention is further explained in details hereinafter with the drawings and embodiments.

Shown as FIG. 2, the present invention provides a device for transmitting audio data over USB through a wireless data terminal, wherein the device mainly comprises a wireless data terminal, USB sound card equipment and terminal equipment; wherein the wireless data terminal is configured to send audio data to the terminal equipment through the USB sound card equipment, and further is configured to receive audio data from the terminal equipment through the USB sound card equipment;

a USB audio data transmission channel between the wireless data terminal and the terminal equipment is set as the USB sound card equipment, which is configured to perform audio data transmission between the wireless data terminal and the terminal equipment;

the terminal equipment is configured to access the USB sound card equipment through its own audio equipment driver to acquire audio data from the wireless data terminal, and further is configured to send audio data to the USB sound card equipment through its own audio equipment driver.

Specifically, the audio equipment driver of the terminal equipment accesses a USB endpoint of the terminal equipment in a manner of accessing the USB sound card equipment interface, reads and releases the audio data transmitted to the USB endpoint of the terminal equipment; subsequently the audio data is transmitted via a UI to a physical sound card to be decoded, subjected to D/A conversion; and finally the audio data is played by a loudspeaker. The audio data gathered by a microphone is subjected to A/D conversion and coded by the physical sound card, and the coded audio data is transmitted to the audio equipment driver via the UI to be compressed, and then the compressed audio data is transmitted to the USB endpoint of the terminal equipment by the audio equipment driver in a manner of accessing the USB sound card equipment interface.

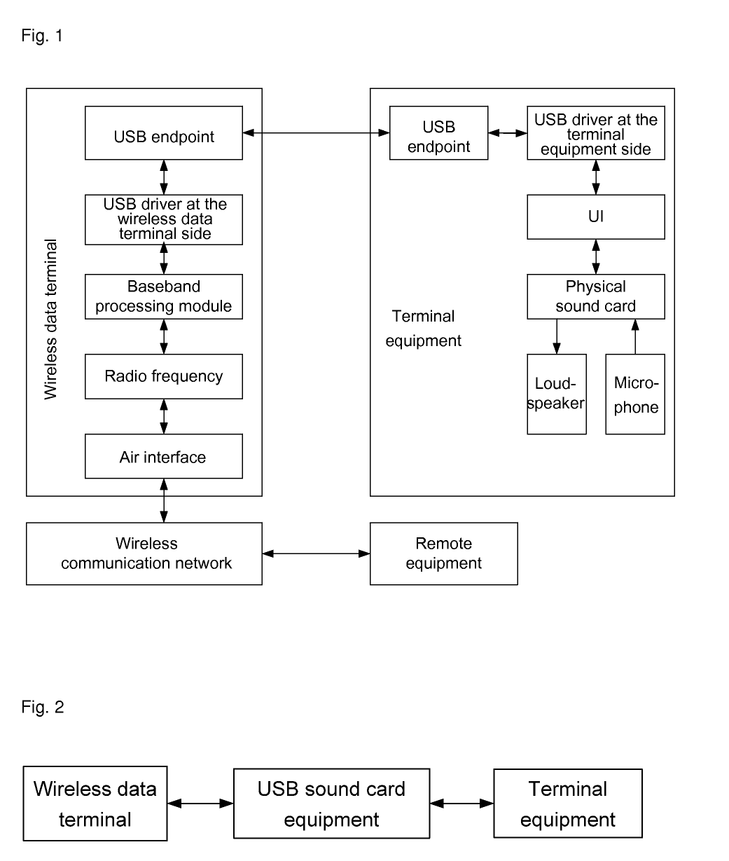

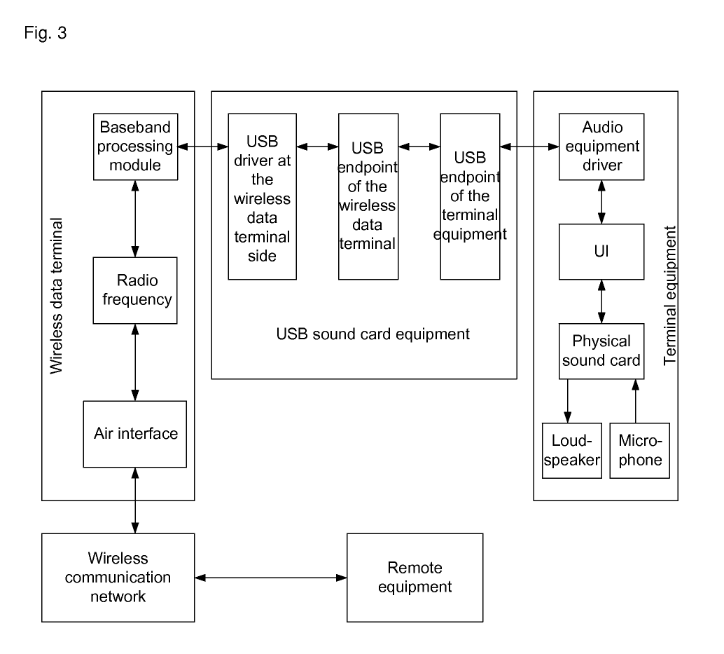

FIG. 3 shows a schematic diagram of setting a USB audio data transmission channel as the USB sound card equipment in the present invention. As shown in FIG. 3, compared with FIG. 1, in the present invention, a USB audio data transmission channel between the wireless data terminal and the terminal equipment is set as the USB sound card equipment in accordance with a USB sound card application method of the USB specification. The USB audio data transmission channel is an audio data transmission channel among a USB driver at the wireless data terminal side, a USB endpoint of wireless data terminal, a USB endpoint of terminal equipment, and the USB data cable between this two USB endpoints. The key for setting a USB audio data transmission channel as the USB sound card equipment is to set the USB audio data transmission channel as the USB sound card equipment by adopting the standard USB AUDIO CLASS defined by the USB specification. Wherein the setting for the USB sound card equipment is realized by the following steps: firstly, the wireless data terminal side defines a USB endpoint of the wireless data terminal transmitting the audio data as a sound card, and connects the USB endpoint of wireless data terminal to USB endpoint of the terminal equipment by the USB data cable; secondly, the terminal equipment sends a request to the wireless data terminal for acquiring such information as a device descriptor, a configuration descriptor and a descriptor assemble of the connected sound card; after receiving the request, the wireless data terminal sends the requested information to the terminal equipment; subsequently, after acquiring the information and determining that the USB driver can be provided according to the information, the terminal equipment loads a corresponding audio equipment driver in accordance with the USB specification; finally, after acquiring all the descriptors, the terminal equipment deems that the information of the connected sound card is complete, and the audio equipment driver configures the sound card, and then the audio data transmission between the wireless data terminal and the terminal equipment can be realized after configuring successfully. By now, the setting process of the USB sound card equipment is completed and the USB audio data transmission channel is set as the USB sound card equipment. The wireless data terminal is connected to the USB driver at the wireless data terminal side of the USB sound card equipment, and the terminal equipment is connected to the USB endpoint of the terminal equipment of the USB sound card equipment.

Different from the audio data processing capability of a physical sound card such as a common USB sound card and its processing capability of directly sending the processed audio data to a loudspeaker to be played, although this USB sound card equipment has a same access interface and a same using way as a physical sound card does, and this USB could be regarded as an actual physical sound card for users, the USB sound card equipment only has an audio data transmission function in fact and does not have actual audio data processing capability, thus the USB sound card needs the help of a physical sound card on the terminal equipment to process the received audio data which needs to be processed. The wireless data terminal will use a wireless communication network to transmit the audio data which is sent from the terminal equipment to the wireless data terminal, to the remote equipment. The remote equipment can be a wireless data terminal or terminal equipment. If the remote equipment needs to process the received audio data, in the case of the remote equipment being terminal equipment, the audio data is directly processed by a physical sound card on the terminal equipment and is subsequently played; in the case of the remote equipment being a wireless data terminal, the received audio data is transmitted to terminal equipment connected with the wireless data terminal through USB sound card equipment and is then played after being processed by a physical sound card on the terminal equipment.

Since the USB audio data transmission channel between the wireless data terminal and the terminal equipment is set as the USB sound card equipment by adopting the standard USB AUDIO CLASS defined by the USB specification to transmit audio data, and the operation system of the broadly-used terminal equipment provides the realization for an audio equipment driver which satisfies the USB specification by default. Regarding the audio data sent by the wireless data terminal to the USB endpoint of the terminal equipment of the USB sound card equipment, the audio equipment driver accesses the USB endpoint of the terminal equipment in the a manner of accessing a sound card equipment interface. When accessing the USB endpoint of the terminal equipment, the audio equipment driver reads and releases the audio data sent to the USB endpoint of the terminal equipment. Compared with the existing way of reading and releasing the audio data by an application UI, the reading and releasing processes performed by the audio equipment driver have a higher priority. Thus, the processing for the audio data has a good real-time performance even when the operation system of the terminal equipment is heavily-loaded. In addition to accessing the USB endpoint of the terminal equipment on a downlink, the audio equipment driver can further provide an audio equipment interface for an uplink; wherein the audio equipment interface is a standard interface. When the UI accesses the audio equipment interface, it need not take notice of the details for realizing the audio equipment driver at the bottom layer. In addition, the operation system has a good portability, so that the UI can access the audio equipment driver via the audio equipment interface and transmit the audio data to the physical sound card, thereby reducing the reliability of the UI on the audio equipment driver and realizing the UI in a simpler and more reliable way.

Specifically, when the terminal equipment acquires the audio data through the USB sound card equipment, the audio equipment driver is configured to access the USB endpoint of the terminal equipment in the a manner of accessing the USB sound card equipment interface, to read and release a PCM code stream transmitted to the USB endpoint of the terminal equipment; the UI is configured to access the audio equipment driver via the audio equipment interface and transmit the PCM code stream to the physical sound card; the physical sound card is configured to acquire an analog audio signal from the PCM code stream.

When the terminal equipment sends the audio data through the USB sound card equipment, the physical sound card is configured to acquire a PCM bit steam from an analog audio signal; the UI is configured to acquire the PCM code stream from the physical sound card and transmit the PCM code stream to the audio equipment driver via the audio equipment interface of the audio equipment driver; the audio equipment driver is configured to send the PCM code stream to the USB endpoint of the terminal equipment.

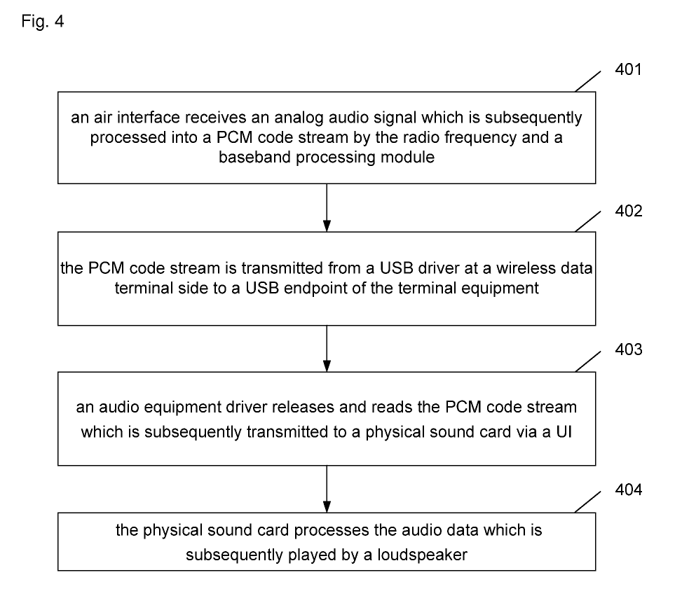

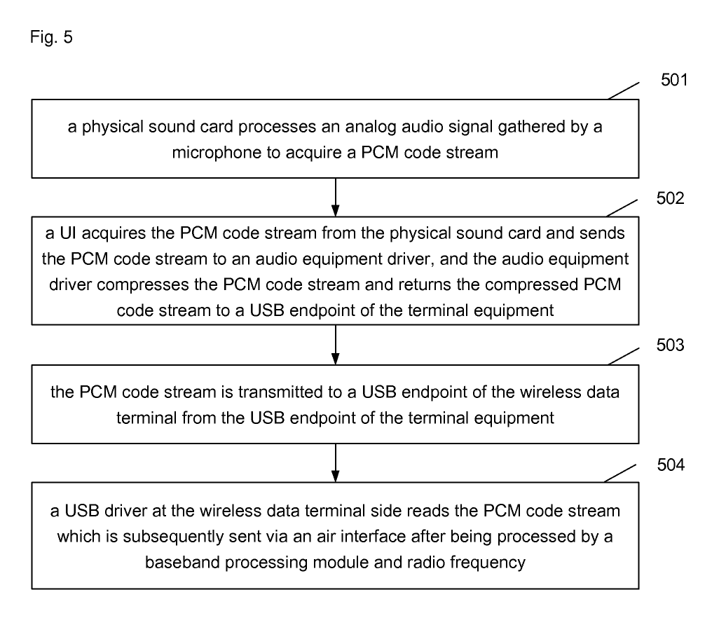

The process for realizing the audio data transmission by USB sound card equipment is shown as FIG. 4 and FIG. 5.

FIG. 4 shows a transmission flowchart taking a wireless data terminal as an audio data receiver. As shown in FIG. 4, an audio data transmission process comprises the following steps:

step 401: an air interface of the wireless data terminal receives an analog audio signal sent from remote equipment through a wireless communication network, and transmits the analog audio signal to a hardware, such as radio frequency, to be demodulated; subsequently, a baseband processing module performs amplification and digital filtering processing on the demodulated audio signal to acquire a PCM code stream;

step 402: the PCM code stream acquired by the processing is transmitted to a USB driver at the wireless data terminal side of the USB sound card equipment by the baseband processing module of the wireless data terminal; subsequently, the PCM code stream is transmitted to a USB endpoint of the terminal equipment of the USB sound card equipment passing through a USB endpoint of the wireless data terminal and a USB data cable in accordance with a synchronous transmission mode of the USB standard;

step 403: after the PCM code stream is transmitted to the USB endpoint of the terminal equipment, an audio equipment driver of the terminal equipment accesses the USB endpoint of the terminal equipment in a manner of accessing an interface of the USB sound card equipment, reads and releases the PCM code stream transmitted to the USB endpoint of the terminal equipment; subsequently, a UI accesses the audio equipment driver via an audio equipment interface and transmits the PCM code stream to a physical sound card;

step 404: the physical sound card performs such processing as decoding and D/A conversion on the transmitted PCM code stream to acquire an analog audio signal, and finally transmits the analog audio signal to a loudspeaker to be played.

FIG. 5 shows a transmission flowchart taking a wireless data terminal as an audio data transmitter. As shown in FIG. 5, the audio data transmission process comprises the following steps:

step 501: a microphone of the terminal equipment transmits a gathered analog audio signal to the physical sound card, and the physical sound card performs such processing as A/D conversion and coding etc. on the analog audio signal to acquire a digital audio signal in the form of PCM code stream;

step 502: the UI of the terminal equipment acquires the PCM code stream from the physical sound card and transmits the PCM code stream to the audio equipment driver via the audio equipment interface of the audio equipment driver, the audio equipment driver compresses the PCM code stream and then transmits the PCM code stream back to the terminal equipment USB endpoint of the USB sound card equipment in a manner of accessing the USB sound card equipment interface;

step 503: after the PCM code stream is transmitted to the USB endpoint of the terminal equipment of the USB sound card equipment, the PCM code stream is transmitted to the USB endpoint of the wireless data terminal of the USB sound card equipment via a USB data cable in accordance with the synchronous transmission mode of the USB standard;

step 504: the baseband processing module of the wireless data terminal uses the USB driver at the wireless data terminal side to acquire the PCM code stream transmitted to the USB endpoint of the wireless data terminal, performs amplification and digital filtering on the PCM code stream, the processed PCM code stream is then modulated into an analog audio signal by the radio frequency, finally, the analog audio signal is sent via the air interface to the remote equipment through the wireless communication network.

What are described above are only preferred embodiments of the present invention and are not used for limiting the protection scope of the present invention.

What is claimed is:

1. A method for transmitting audio data over Universal Serial Bus (USB) through a wireless data terminal, a USB audio data transmission channel between a wireless data terminal and terminal equipment being set as USB sound card equipment, the method comprising:
the wireless data terminal sending audio data to the terminal equipment through the USB sound card equipment, and the terminal equipment using its audio equipment driver to access the USB sound card equipment to acquire the audio data; and
the terminal equipment using its audio equipment driver to send the audio data to the USB sound card equipment, and the wireless data terminal receiving the audio data through the USB sound card equipment.

2. The method according to claim 1, wherein the step of the USB audio data transmission channel between the wireless data terminal and the terminal equipment is set as the USB sound card equipment comprises:
the wireless data terminal defines a USB endpoint of the wireless data terminal, wherein the USB endpoint transmits the audio data as a sound card and the USB endpoint of the wireless data terminal is connected to a USB endpoint of the terminal equipment via a USB data cable;
the terminal equipment sends a request to the wireless data terminal for acquiring a device descriptor, a configuration descriptor and a descriptor assemble; after receiving the request, the wireless data terminal sends the device descriptor, the configuration descriptor and the descriptor assemble to the terminal equipment; and
after determining that a USB driver can be provided according to the device descriptor, the configuration descriptor and the descriptor assemble, the terminal equipment loads a corresponding audio equipment driver in accordance with a USB specification, and the audio equipment driver configures the sound card to obtain the USB sound card equipment.

3. The method according to claim 1, wherein the terminal equipment comprises an audio equipment driver, a User Interface (UI) and a physical sound card;
the step that the terminal equipment uses its audio equipment driver to access the USB sound card equipment to acquire audio data comprises that: the audio equipment driver accesses the USB sound card equipment in a manner of accessing an interface of the USB sound card equipment, releases and reads a Pulse Code Modulation (PCM) code stream transmitted to the USB sound card equipment; the UI accesses the audio equipment driver via an audio equipment interface and transmits the PCM code stream to the physical sound card.

4. The method according to claim 1, wherein the terminal equipment comprises an audio equipment driver, a UI and a physical sound card;
the step that the terminal equipment uses its audio equipment driver to send the audio data to the USB sound card equipment comprises that: the physical sound card acquires a PCM code stream from an analog audio signal; the UI acquires the PCM code stream from the physical sound card and transmits the PCM code stream to the audio equipment driver via an audio equipment interface of the audio equipment driver;
the audio equipment driver sends the PCM code stream to the USB sound card equipment.

5. The method according to claim 1, wherein the step that the wireless data terminal transmits the audio data to the terminal equipment through the USB sound card equipment comprises that: a baseband processing module of the wireless data terminal transmits a PCM code stream acquired after being processed to a USB driver at the wireless data terminal side of the USB sound card equipment.

6. The method according to claim 1, wherein the step that the wireless data terminal receives the audio data through the USB sound card equipment comprises that: a baseband processing module of the wireless data terminal acquires a PCM code stream transmitted to a USB endpoint of the wireless data terminal through a USB driver at the wireless data terminal side of the USB sound card equipment.

7. A device for transmitting audio data over USB through a wireless data terminal, comprising:
a wireless data terminal, which is configured to send audio data to terminal equipment through USB sound card equipment, and further configured to receive the audio data from the terminal equipment through the USB sound card equipment;
USB sound card equipment, which is set based on a USB audio data transmission channel between the wireless data terminal and the terminal equipment, and configured to transmit the audio data between the wireless data terminal and the terminal equipment; and
terminal equipment, which is configured to use its audio equipment driver to access the USB sound card equipment to acquire the audio data from the wireless data terminal and further configured to use its audio equipment driver to send the audio data to the USB sound card equipment.

8. The device according to claim 7, wherein the USB sound card equipment comprises: a USB driver at the wireless data terminal side, a USB endpoint of the wireless data terminal and a USB endpoint of the terminal equipment;
the USB driver at the wireless data terminal side is connected with a baseband processing module of the wireless data terminal;
the USB endpoint of the wireless data terminal is connected with the USB endpoint of the terminal equipment via a USB data cable; and
the USB endpoint of the terminal equipment is connected with the audio equipment driver of the terminal equipment.

9. The device according to claim 8, wherein when the terminal equipment is configured to use its audio equipment driver to access the USB sound card equipment to acquire the audio data from the wireless data terminal, the terminal equipment comprises:
an audio equipment driver, which is configured to access the USB endpoint of the terminal equipment in a manner of accessing an interface of the USB sound card equipment, read and release a PCM code stream transmitted to the USB endpoint of the terminal equipment;
a UI, which is configured to access the audio equipment driver via an audio equipment interface, and transmit the PCM code stream to a physical sound card; and
a physical sound card, which is configured to acquire an analog audio signal from the PCM code stream.

10. The device according to claim 8, wherein when the terminal equipment is configured to use its audio equipment driver to send the audio data to the USB sound card equipment, the terminal equipment comprises:
a physical sound card, which is configured to acquiring a PCM code stream from an analog audio signal;
a UI, which is configured to acquire the PCM code stream from the physical sound card, and transmit the PCM code stream to the audio equipment driver via an audio equipment interface of the audio equipment driver; and
an audio equipment driver, which is configured to send the PCM code stream to the USB endpoint of the terminal equipment.

11. The method according to claim 2, wherein the step that the wireless data terminal transmits the audio data to the terminal equipment through the USB sound card equipment comprises that: a baseband processing module of the wireless data terminal transmits a PCM code stream acquired after being processed to a USB driver at the wireless data terminal side of the USB sound card equipment.

12. The method according to claim 3, wherein the step that the wireless data terminal transmits the audio data to the terminal equipment through the USB sound card equipment comprises that: a baseband processing module of the wireless data terminal transmits a PCM code stream acquired after being processed to a USB driver at the wireless data terminal side of the USB sound card equipment.

13. The method according to claim 4, wherein the step that the wireless data terminal transmits the audio data to the terminal equipment through the USB sound card equipment comprises that: a baseband processing module of the wireless data terminal transmits a PCM code stream acquired after being processed to a USB driver at the wireless data terminal side of the USB sound card equipment.

14. The method according to claim 2, wherein the step that the wireless data terminal receives the audio data through the USB sound card equipment comprises that: a baseband processing module of the wireless data terminal acquires a PCM code stream transmitted to a USB endpoint of the wireless data terminal through a USB driver at the wireless data terminal side of the USB sound card equipment.

15. The method according to claim 3, wherein the step that the wireless data terminal receives the audio data through the USB sound card equipment comprises that: a baseband processing module of the wireless data terminal acquires a PCM code stream transmitted to a USB endpoint of the wireless data terminal through a USB driver at the wireless data terminal side of the USB sound card equipment.

16. The method according to claim 4, wherein the step that the wireless data terminal receives the audio data through the USB sound card equipment comprises that: a baseband processing module of the wireless data terminal acquires a PCM code stream transmitted to a USB endpoint of the wireless data terminal through a USB driver at the wireless data terminal side of the USB sound card equipment.
